(19) United States
(12) Patent Application Publication
(10) Pub. No.: US 2020/0082994 A1
(43) Pub. Date: Mar. 12, 2020

(54) ELECTROLYTIC CAPACITOR AND METHOD FOR MANUFACTURING SAME

(71) Applicant: Panasonic Intellectual Property Management Co., Ltd., Osaka (JP)

(72) Inventor: HITOSHI FUKUI, Nara (JP)

(21) Appl. No.: 16/682,197

(22) Filed: Nov. 13, 2019

Related U.S. Application Data
(63) Continuation-in-part of application No. PCT/JP2018/016897, filed on Apr. 26, 2018.

(30) Foreign Application Priority Data
May 31, 2017 (JP) 2017-108090

(51) Int. Cl. H01G 9/15; H01G 9/00; H01G 9/042; H01G 11/48; H01B 1/12

(52) U.S. Cl. CPC H01G 9/15; H01G 9/0036; H01B 1/127; H01G 11/48; H01G 9/042

(57) ABSTRACT

An electrolytic capacitor includes an anode body, a dielectric layer disposed on the anode body, and a solid electrolyte layer disposed on the dielectric layer. The solid electrolyte layer includes a conductive polymer. The conductive polymer contains a self-doped poly(3,4-ethylenedioxythiophene)-based polymer.

### RELATED APPLICATIONS

This application is a continuation-in-part of the PCT International Application No. PCT/JP2018/016897 filed on Apr. 26, 2018, which claims the benefit of foreign priority of Japanese patent application No. 2017-108090 filed on May 31, 2017, the contents all of which are incorporated herein by reference.

### TECHNICAL FIELD

As capacitors having a small size, a large capacitance, and a low equivalent series resistance (ESR), promising candidates are electrolytic capacitors including an anode body, a dielectric layer disposed on the anode body, and a solid electrolyte layer, which includes a conductive polymer, disposed on the dielectric layer.

In Unexamined Japanese Patent Publication No. 2007-110074, it is proposed that a solid electrolytic capacitor includes a conductive polymer layer containing self-doped conductive polymer having isothianaphthene skeleton. In International Publication No. 2013/081099, it is proposed that a solid electrolytic capacitor includes an amine-containing layer and a conductive polymer layer containing a self-doped conductive polymer such as polyanilinesulfonic acid and poly(isothianaphthenediyl-sulfonate).

### SUMMARY

The ESR may possibly increase in high-temperature environments depending on a type of the conductive polymer.

An electrolytic capacitor according to first aspect of the present disclosure includes an anode body, a dielectric layer disposed on the anode body, and a solid electrolyte layer disposed on the dielectric layer. The solid electrolyte layer includes a conductive polymer. And the conductive polymer contains a self-doped poly(3,4-ethylenedioxythiophene)-based polymer.

A method for manufacturing an electrolytic capacitor according to second aspect of the present disclosure includes a step of preparing an anode body on which a dielectric layer is disposed and a step of forming a solid electrolyte layer, which includes a self-doped poly(3,4-ethylenedioxythiophene)-based polymer, on the dielectric layer. The step of forming the solid electrolyte layer includes a step of forming a first conductive polymer layer that contains a self-doped poly(3,4-ethylenedioxythiophene)-based polymer as a first conductive polymer, by attaching a first liquid composition that contains the self-doped poly(3,4-ethylenedioxythiophene)-based polymer onto the dielectric layer.

According to the present disclosure, an electrolytic capacitor that maintains a low ESR even in high-temperature environments can be provided, and a method for manufacturing the electrolytic capacitor can be provided.

### BRIEF DESCRIPTION OF DRAWING

FIG. 1 is a schematic sectional view illustrating an electrolytic capacitor according to one exemplary embodiment of the present disclosure.

### DESCRIPTION OF EMBODIMENTS

[Electrolytic Capacitor]

An electrolytic capacitor according to an exemplary embodiment of the present disclosure includes an anode body, a dielectric layer disposed on the anode body, and a solid electrolyte layer disposed on the dielectric layer.

(Solid Electrolyte Layer)

In the present exemplary embodiment, the solid electrolyte layer includes a conductive polymer, and the conductive polymer contains a self-doped poly(3,4-ethylenedioxythiophene)-based polymer (first conductive polymer).

The self-doped conductive polymer (e.g., the poly(3,4-ethylenedioxythiophene)-based polymer) refers to a conductive polymer having an anionic group directly or indirectly bonded to a conductive polymer skeleton (e.g., a poly(3,4-ethylenedioxythiophene) skeleton) via covalent bonding. This anionic group, which is included in the conductive polymer itself, functions as a dopant of the conductive polymer. Hence, this kind of the conductive polymer is referred to as self-doped conductive polymer. The anionic group includes, for example, an acidic group (acid type) or a conjugated-anion group (salt type) of the acidic group.

Conventionally, polyaniline having an anionic group or polyisothianaphthene having an anionic group is used as the self-doped conductive polymer. The ESR, however, increases when the electrolytic capacitor that includes a solid electrolyte layer containing the self-doped polyaniline or the self-doped polyisothianaphthene is exposed to high-temperature environments. This is considered to be because the high-temperature environments cause a decrease in electric conductivity of the solid electrolyte layer, a decrease in film-shape stability due to, for example, a crack on the solid electrolyte layer, or a decrease of adhesiveness in an interface between a layer containing the self-doped conductive polymer and a layer adjacent to this layer.

In contrast, according to the present exemplary embodiment, use of the self-doped poly(3,4-ethylenedioxythiophene)-based polymer (first conductive polymer) enables suppression of the increase of the ESR in the high-temperature environments, compared to cases where a polyaniline-based or polyisothianaphthene-based polymer is used. This is considered to be because the skeleton of the first conductive polymer has higher heat resistance than a skeleton of, for example, the polyaniline-based polymer, so that the first conductive polymer is less likely to be deteriorated in the high-temperature environments. The use of the first conductive polymer suppresses deterioration of the solid electrolyte layer even in the high-temperature environments and thus enables suppression of generation of a crack or fracture on the solid electrolyte layer. This is considered to result in suppressing an increase of resistance in the solid electrolyte layer to allow the solid electrolyte layer to maintain high electric conductivity, so that the increase of the ESR in the high-temperature environments is suppressed. It is generally assumed that the first conductive polymer has low heat resistance because the first conductive polymer has more ether bonds than the polyisothianaphthene-based polymer. Contrary to this assumption, the increase of the ESR in the high-temperature environments is suppressed in the present exemplary embodiment. A reason for this is considered to be because the first conductive polymer that has many ether bonds facilitates maintenance of high adhesiveness in an interface between a layer containing the first conductive polymer and a layer adjacent to this layer.

The first conductive polymer contains, for example, a poly(3,4-ethylenedioxythiophene)-based polymer having an anionic group. Examples of the anionic group include a sulfonate group, a carboxy group, a phosphate group, a phosphonate group, and salts of these groups (e.g., a salt with an inorganic base or a salt with an organic base). The poly(3,4-ethylenedioxythiophene)-based polymer may have one type of anionic group or two or more types of anionic groups. As the anionic group, a sulfonate group or a salt of the sulfonate group is preferred, and a combination of a sulfonate group or a salt of the sulfonate group with an anionic group other than the sulfonate group or the salt of the sulfonate group is also acceptable.

The poly(3,4-ethylenedioxythiophene)-based polymer include, for example, a homopolymer of 3,4-ethylenedioxythiophene (EDOT), a copolymer of EDOT with a copolymerizable monomer, and derivatives of these polymers (e.g., a substitution product having a substituent). These polymers having the anionic group and derivatives of these polymers are first conductive polymers.

A weight-average molecular weight of the first conductive polymer is not particularly limited, and ranges, for example, from 1,000 to 1,000,000, inclusive.

The solid electrolyte layer may include a first conductive polymer layer, which contains the first conductive polymer, disposed on the dielectric layer, and a second conductive polymer layer, which contains a second conductive polymer, disposed on the first conductive polymer layer. The second conductive polymer layer may be a single layer or may be composed of a plurality of layers. When a surface of the dielectric layer has a region where the first conductive polymer layer is not formed, the second conductive polymer layer may be formed on this region in the surface of the dielectric layer.

The first conductive polymer layer may contain a conductive polymer (for example, a non-self-doped conductive polymer) other than the first conductive polymer, but preferably has a high content ratio of the first conductive polymer. A proportion of the first conductive polymer in entire conductive polymers included in the first conductive polymer layer is, for example, more than or equal to 90 wt % and may also be 100 wt %.

Although the first conductive polymer has the anionic group, the first conductive polymer layer may also contain a dopant as necessary. An anion and/or a polyanion, for example, may be used as the dopant. The anion and/or the polyanion may form a conductive polymer complex with the conductive polymer in the first conductive polymer layer. In the present specification, the conductive polymer complex refers to the conductive polymer doped with the anion and/or the polyanion, the conductive polymer to which the anion is bonded, and the conductive polymer to which the polyanion is bonded via an anionic group of the polyanion.

Examples of the anion include a sulfate ion, a nitrate ion, a phosphate ion, a borate ion, and an organic sulfonate ion, and the anion is not particularly limited. The anion may be contained in a salt form in the first conductive polymer layer.

The polyanion has an anionic group such as a sulfonate group, a carboxy group, a phosphate group, a phosphonate group, and salts of these groups. The polyanion may have one type of anionic group or two or more types of anionic groups. As the anionic group, a sulfonate group or a salt of the sulfonate group is preferred, and a combination of a sulfonate group or a salt of the sulfonate group with an anionic group other than the sulfonate group or the salt of the sulfonate group is also acceptable. Examples of the polyanion include polyvinylsulfonic acid, polystyrenesulfonic acid, polyallylsulfonic acid, polyacrylsulfonic acid, polymethacrylsulfonic acid, poly (2-acrylamido-2-methylpropanesulfonic acid), polyisoprenesulfonic acid, polyacrylic acid, and salts of these acids. These polyanions may be used alone or in combination of two or more types of polyanions. These polyanions may be a homopolymer or a copolymer of two or more types of monomers. Particularly, polystyrenesulfonic acid (PSS) is preferred.

A weight-average molecular weight of the polyanion ranges, for example, from 1000 to 1,000,000, inclusive.

A content ratio of the dopant to the first conductive polymer layer ranges, for example, from 0 parts by mass to 40 parts by mass, preferably from 0 parts by mass to 10 parts by mass or from 0.1 parts by mass to 10 parts by mass, with respect to 100 parts by mass of the first conductive polymer.

As the second conductive polymer, a conductive polymer different from the first conductive polymer is usually used, and a non-self-doped conductive polymer is preferred. The non-self-doped conductive polymer refers to a conductive polymer not having an anionic group (specifically, a sulfonate group, a carboxy group, a phosphate group, a phosphonate group, and salts of these groups) directly or indirectly bonded to a conductive polymer skeleton via covalent bonding.

Polypyrrole, polythiophene, and polyaniline, for example, are preferred as the non-self-doped conductive polymer. These non-self-doped conductive polymers may be used alone or in combination of two or more types of non-self-doped conductive polymers, or the non-self-doped conductive polymer may be a copolymer of two or more types of monomers. In the present specification, polypyrrole, polythiophene, polyaniline, and the like mean polymers having, as a basic skeleton, polypyrrole, polythiophene, polyaniline, and the like, respectively. Therefore, polypyrrole, polythiophene, polyaniline, and the like can also include derivatives (e.g., substitution products having a substituent other than the anionic group) of polypyrrole, polythiophene, polyaniline, and the like, respectively. For example, the polythiophene includes poly(3,4-ethylenedioxythiophene) (PEDOT) and the like. Among these non-self-doped conductive polymers, polypyrrole (including a derivative of polypyrrole) is preferred from a viewpoint of attaining both high heat resistance and high moisture resistance characteristics.

A weight-average molecular weight of the second conductive polymer is not particularly limited, and ranges, for example, from 1,000 to 1,000,000, inclusive. When the second conductive polymer layer is formed of a plurality of layers, the second conductive polymers contained in the layers may be the same or different.

The second conductive polymer layer can further contain a dopant. An anion and/or a polyanion, for example, is used as the dopant. Each of the anion and the polyanion may be selected from those described for the first conductive polymer layer. The anion or the polyanion may form a conductive polymer complex with the conductive polymer in the second conductive polymer layer.

The first conductive polymer layer preferably has a smaller thickness than a thickness of the second conductive polymer layer. Such a configuration enables the first conductive polymer layer to cover as many areas of a surface of the dielectric layer formed along a surface of the anode body (specifically, the surface including inner wall surfaces of a pore and a pit of the anode body) as possible. Hence, acquisition of high heat resistance can be facilitated. And by forming the second conductive polymer layer having a large thickness, leakage current can be suppressed.

The thicknesses of the layers can be measured by an electron micrograph of a section along a thickness direction of the solid electrolyte layer.

The solid electrolyte layer may further contain an alkaline component as necessary. The alkaline component may be contained in the first conductive polymer layer and/or the second conductive polymer layer. An inorganic alkaline compound or an organic alkaline compound, for example, may be used as the alkaline component. Examples of the inorganic alkaline compound include ammonia and metallic hydroxides such as sodium hydroxide and calcium hydroxide. An amine compound, for example, is preferred as the organic alkaline compound. An aliphatic amine and a cyclic amine, for example, are preferred as the amine compound. The alkaline components may be used alone or in combination of two or more types of alkaline components. The alkaline component may form a salt with the conductive polymer and/or the dopant in the solid electrolyte layer.

The solid electrolyte layer may further contain another component within a range not impairing the effect of the present disclosure.

(Anode Body)

The anode body contains, for example, a valve metal or an alloy containing a valve metal. Aluminum, tantalum, niobium, or titanium, for example, is preferably used as the valve metal. The valve metals may be used alone or in combination of two or more types of valve metals. The anode body can be obtained by, for example, etching a surface of a base material (such as a foil-shaped or plate-shaped base material) containing the valve metal, to roughen the surface. Further, the anode body may be a molded body of particles containing the valve metal or a sintered body of the molded body. The sintered body has a porous structure. That is, when the anode body is a sintered body, the anode body can be entirely porous.

(Dielectric Layer)

The dielectric layer is formed by anodizing through, for example, an anodizing treatment, the valve metal on the surface of the anode body. The dielectric layer contains an oxide of the valve metal. For example, when tantalum is used as the valve metal, the dielectric layer contains Ta₂O₅, and when aluminum is used as the valve metal, the dielectric layer contains Al₂O₃. The dielectric layer is not limited to these examples, and is satisfactory as long as the dielectric layer functions as a dielectric substance. When the surface of the anode body is porous, the dielectric layer is formed along the surface of the anode body (the surface including inner wall surfaces of a pore and a pit of the anode body).

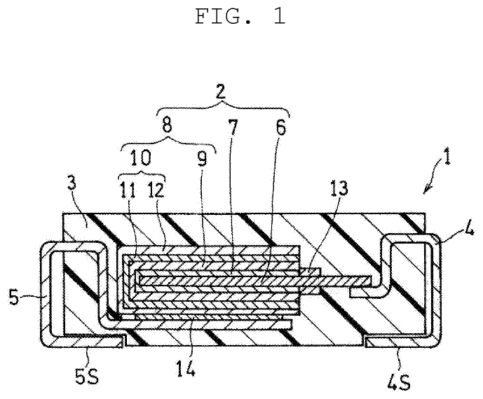

FIG. 1 is a sectional view schematically illustrating a structure of an electrolytic capacitor according to one exemplary embodiment of the present disclosure. As shown in FIG. 1, electrolytic capacitor 1 includes capacitor element 2, resin sealing member 3 for sealing capacitor element 2, and anode terminal 4 and cathode terminal 5 each of which is at least partially exposed to an outside of resin sealing member 3. Anode terminal 4 and cathode terminal 5 can be made of, for example, a metal such as copper or a copper alloy. Resin sealing member 3 has a substantially rectangular parallelepiped outer shape, and electrolytic capacitor 1 also has a substantially rectangular parallelepiped outer shape. As a material for resin sealing member 3, for example, an epoxy resin can be used.

Capacitor element 2 includes anode body 6, dielectric layer 7 covering anode body 6, and cathode part 8 covering dielectric layer 7. Cathode part 8 includes solid electrolyte layer 9 that covers dielectric layer 7 and cathode lead-out layer 10 that covers solid electrolyte layer 9. Cathode lead-out layer 10 includes carbon layer 11 and silver paste layer 12.

Anode body 6 includes an area opposed to cathode part 8 and an area that is not opposed to cathode part 8. In the area of anode body 6 that is not opposed to cathode part 8, insulating separation layer 13 is formed in a portion adjacent to cathode part 8 so as to zonally cover a surface of anode body 6. Hence, contact between cathode part 8 and anode body 6 is restricted. In the area of anode body 6 that is not opposed to cathode part 8, another portion is electrically connected to anode terminal 4 by welding. Cathode terminal 5 is electrically connected to cathode part 8 via adhesive layer 14 made of a conductive adhesive.

A base material (such as a foil-shaped or plate-shaped base material) containing a valve metal, whose surface is roughened, is used as anode body 6. An aluminum foil whose surface is roughened by etching, for example, is used. Dielectric layer 7 contains, for example, an aluminum oxide such as Al₂O₃.

Principal surface 4S of anode terminal 4 and principal surface 5S of cathode terminal 5 are exposed from a same surface of resin sealing member 3. These exposed surfaces are used for solder connection with a substrate (not shown) on which electrolytic capacitor 1 is to be mounted.

Carbon layer 11 is satisfactory as long as the carbon layer has conductivity, and the carbon layer can be formed using, for example, a conductive carbon material such as graphite. A composition containing a silver powder and a binder resin (such as an epoxy resin), for example, can be used for silver paste layer 12. A configuration of cathode lead-out layer 10 is not limited to this example, and is satisfactory as long as the cathode lead-out layer is configured to have a current collection function.

Solid electrolyte layer 9 is formed so as to cover dielectric layer 7. Solid electrolyte layer 9 does not necessarily cover whole (a whole surface of) dielectric layer 7, and is satisfactory as long as the solid electrolyte layer is formed so as to cover at least a part of dielectric layer 7.

Dielectric layer 7 is formed along the surface (the surface including an inner wall surface of a pore) of anode body 6. A surface of dielectric layer 7 is formed to have an irregular shape corresponding to a shape of the surface of anode body 6. Solid electrolyte layer 9 is preferably formed so as to fill such irregularities of dielectric layer 7.

A configuration of the electrolytic capacitor according to the present disclosure is not limited to the electrolytic capacitor having the structure described above, and is applicable to any of variously structured electrolytic capacitors. Specifically, the present disclosure is also applicable to, for example, a wound electrolytic capacitor and an electrolytic capacitor including a metal powder sintered body as the anode body.

[Method for Manufacturing Electrolytic Capacitor]

A method for manufacturing an electrolytic capacitor according to an exemplary embodiment of the present disclosure includes preparing an anode body on which a dielectric layer is disposed (first step), and forming a solid electrolyte layer that contains a first conductive polymer on the dielectric layer (second step). The second step includes forming a first conductive polymer layer that contains the first conductive polymer, by attaching a first liquid composition that contains the first conductive polymer onto the dielectric layer. The second step may further include forming a second conductive polymer layer that contains a second conductive polymer, by attaching a second liquid composition that contains the second conductive polymer or a precursor of the second conductive polymer onto the first conductive polymer layer. The method for manufacturing an electrolytic capacitor may include preparing the anode body prior to the first step. The manufacturing method may also include further forming a cathode lead-out layer.

Hereinafter, the steps are described in more detail.

(Preparing Anode Body)

In this step, an anode body is formed by a publicly known method according to a type of the anode body.

The anode body can be prepared by, for example, roughening a surface of a foil-shaped or plate-shaped base material containing a valve metal. The roughening is satisfactory as long as irregularities can be formed on the surface of the base material, and may be performed by, for example, etching (for example, electrolytic etching) the surface of the base material.

Alternatively, a valve metal powder is prepared and formed into a desired shape (for example, a block shape) while one longitudinal end of a rod-shaped anode lead is embedded in this powder, to give a molded body. This molded body may be sintered to form a porous-structure anode body in which one end of the anode lead is embedded.

(First Step)

In the first step, a dielectric layer is formed on the anode body. The dielectric layer is formed by anodizing the anode body. The anodizing can be performed by a publicly known method, for example, an anodizing treatment. The anodizing treatment can be performed by, for example, immersing the anode body in an anodizing solution to impregnate a surface of the anode body with the anodizing solution, and applying a voltage between the anode body as an anode and a cathode immersed in the anodizing solution. Preferably, a phosphoric acid aqueous solution, for example, is used as the anodizing solution.

(Second Step)

In the second step, a solid electrolyte layer is formed so as to cover at least a part of the dielectric layer. The solid electrolyte layer includes at least a first conductive polymer layer containing a first conductive polymer. Hence, at least the first conductive polymer layer is formed in the second step. The first conductive polymer layer is formed using a first liquid composition containing the first conductive polymer. In the second step, a second conductive polymer layer may further be formed by attaching a second liquid composition onto the first conductive polymer layer after the formation of the first conductive polymer layer. The manufacturing method according to the present exemplary embodiment may include preparing the first liquid composition prior to the forming the first conductive polymer layer. Further, the manufacturing method may also include preparing the second liquid composition prior to the forming the second conductive polymer layer.

(Preparing First Liquid Composition)

In the present step, the first liquid composition that contains the first conductive polymer, and a disperse medium or a solvent is prepared. As the first conductive polymer, those exemplified above can be used. The first liquid composition may also contain a polyanion, an alkaline component, and/or another additional component as necessary.

The first liquid composition is, for example, a dispersion liquid (solution) of the first conductive polymer. The first liquid composition may contain a conductive polymer complex of the first conductive polymer with a polyanion. Particles of the conductive polymer (or the conductive polymer complex) in the first liquid composition has an average particle size ranging, for example, from 5 nm to 800 nm, inclusive. The average particle size of the conductive polymer (or the conductive polymer complex) can be obtained from, for example, particle size distribution by a dynamic light scattering method.

Examples of the disperse medium (solvent) used for the first liquid composition include water, an organic solvent, and a mixture of water and an organic solvent. Examples of the organic solvent include monohydric alcohols such as methanol, ethanol and prop anol, polyhydric alcohols such as ethylene glycol and glycerin, and aprotic polar solvents such as N,N-dimethylformamide, dimethylsulfoxide, acetonitrile, acetone, and benzonitrile.

The first liquid composition can be obtained by, for example, oxidatively polymerizing a precursor of the first conductive polymer in the disperse medium (solvent). Examples of this precursor include a monomer constituting the first conductive polymer and/or an oligomer in which some monomers are linked to each other. The first liquid composition containing the conductive polymer complex can be obtained by, for example, oxidatively polymerizing the precursor of the first conductive polymer in presence of the dopant in the disperse medium (solvent).

(Forming First Conductive Polymer Layer)

The first conductive polymer layer is formed by attaching the first liquid composition onto the dielectric layer. The forming of the first conductive polymer layer includes, for example, a step A of immersing the anode body on which the dielectric layer has been formed in the first liquid composition, or applying or dropping the first liquid composition to the anode body on which the dielectric layer has been formed, and then drying the first liquid composition. The step A may be repeated a plurality of times.

(Preparing Second Liquid Composition)

The second liquid composition contains the second conductive polymer or a precursor of the second conductive polymer, and a disperse medium (solvent) together with a dopant as necessary. As the second conductive polymer and the dopant, those exemplified above can be used. Examples of the precursor of the second conductive polymer include a monomer constituting the second conductive polymer and/or an oligomer in which some monomers are linked to each other. As the disperse medium (solvent), those exemplified for the first liquid composition can be used. The second liquid composition may further contain an alkaline component and/or another component.

As the second liquid composition, for example, a dispersion liquid (solution) of the second conductive polymer or a dispersion liquid (solution) of a conductive polymer complex of the second conductive polymer with the dopant may be used. The second liquid composition may be prepared in accordance with a case of the first liquid composition.

The second conductive polymer layer may be formed by chemical polymerization or electrolytic polymerization. In the chemical polymerization, the second conductive polymer layer is formed using the second liquid composition containing, for example, the precursor of the second conductive polymer, the disperse medium (or the solvent), and an oxidant together with the dopant as necessary. In the electrolytic polymerization, the second conductive polymer layer is formed using the second liquid composition containing, for example, the precursor of the second conductive polymer and the disperse medium (or the solvent) together with the dopant as necessary.

(Forming Second Conductive Polymer Layer)

The second conductive polymer layer is formed by attaching the second liquid composition onto the first conductive polymer layer.

When the dispersion liquid (or the solution) containing the second conductive polymer is used as the second liquid composition, the forming of the second conductive polymer layer includes, for example, a step B of immersing the first conductive polymer layer in the second liquid composition, or applying or dropping the second liquid composition onto the first conductive polymer layer, and then drying the second liquid composition. The step B may be repeated a plurality of times.

When the second conductive polymer layer is formed by the chemical polymerization, the forming of the second conductive polymer layer includes a step C of immersing the first conductive polymer layer in the second liquid composition, or applying or dropping the second liquid composition onto the first conductive polymer layer, to attach the second liquid composition to the first conductive polymer layer, and then heating the second liquid composition. The heating promotes polymerization of the precursor of the second conductive polymer to form the second conductive polymer layer. The step C may be repeated a plurality of times.

When the second conductive polymer layer is formed by the electrolytic polymerization, the forming of the second conductive polymer layer includes a step of immersing the first conductive polymer layer in the second liquid composition, and supplying power from a supply electrode with using the first conductive polymer layer as an electrode. This step promotes polymerization of the precursor of the second conductive polymer to form the second conductive polymer layer.

A washing treatment may be performed as necessary after the chemical polymerization or the electrolytic polymerization.

In order to form the second conductive polymer layer having a sufficient thickness, an average particle size of particles of the conductive polymer (or the conductive polymer complex) used in the second conductive polymer layer may be set larger than an average particle size of particles of the conductive polymer (or the conductive polymer complex) used in the first conductive polymer layer. For a similar purpose, the second liquid composition may be used that has a higher solid content concentration of the conductive polymer (or the conductive polymer complex) than the first liquid composition. Further, for a similar purpose, the step B or C may be increased in number of times, and a period for supplying power may be prolonged or current may be increased in the electrolytic polymerization.

(Forming Cathode Lead-Out Layer)

In this step, a cathode lead-out layer is formed by sequentially stacking a carbon layer and a silver paste layer on a surface of the anode body (preferably the solid electrolyte layer formed) obtained in the second step.

### EXAMPLES

Hereinafter, the present disclosure is specifically described with reference to an example and comparative examples. The present disclosure, however, is not limited to the example below.

### Example 1

Electrolytic capacitor 1 shown in FIG. 1 was produced as described below, and characteristics of the electrolytic capacitor were evaluated.

(1) Preparing Anode Body

An aluminum foil (thickness: 100 μm) was prepared as a base material, and a surface of the aluminum foil was etched to give anode body 6.

(2) Forming Dielectric Layer

Anode body 6 was immersed in a solution of phosphoric acid at 0.3 wt % (liquid temperature: 70° C.), and a DC (direct current) voltage of 70 V was applied for 20 minutes, to form dielectric layer 7 containing aluminum oxide (Al₂O₃) on a surface of anode body 6. After that, an insulating resist tape (separation layer 13) was attached to a prescribed position of anode body 6.

(3) Preparing First Liquid Composition

An aqueous dispersion liquid (first liquid composition) was prepared. The first liquid composition contained a first conductive polymer and an alkaline component. A concentration of the first conductive polymer in the first liquid composition was 2 wt %, and an average particle size of the first conductive polymer was 400 nm. Poly(3,4-ethylenedioxythiophene) having a sulfonate group directly bonded to a poly(3,4-ethylenedioxythiophene) skeleton was used as the first conductive polymer, and diethylamine was used as the alkaline component.

(4) Forming First Conductive Polymer Layer

Anode body 6 on which dielectric layer 7 had been formed was immersed in the first liquid composition, and then the first liquid composition was dried at 120° C. for 10 minutes to 30 minutes. This step of immersing and drying was repeated twice to form a first conductive polymer layer.

(5) Preparing Second Liquid Composition

An aqueous dispersion liquid (second liquid composition) was prepared. The second liquid composition contained pyrrole and a dopant (naphthalenesulfonic acid). A concentration of pyrrole in the second liquid composition was set at 4 wt %, and a concentration of the dopant in the second liquid composition was set at 6 wt %.

(6) Forming Second Conductive Polymer Layer

The anode body on which the first conductive polymer layer had been formed was immersed in the second liquid composition. And electrolytic polymerization of pyrrole was promoted, with the first conductive polymer layer used as an electrode, to form a second conductive polymer layer containing polypyrrole as a second conductive polymer.

In this manner, solid electrolyte layer 9 constituted by the first conductive polymer layer and the second conductive polymer layer was formed.

(7) Forming Cathode Lead-Out Layer

A dispersion liquid obtained by dispersing graphite particles in water was applied to a surface of solid electrolyte layer 9, and was then dried in air to form carbon layer 11 on a surface of the second conductive polymer layer.

Next, a silver paste containing silver particles and a binder resin (epoxy resin) was applied to a surface of carbon layer 11, and then the binder resin was cured by heating to form silver paste layer 12. In this manner, cathode lead-out layer 10 constituted by carbon layer 11 and silver paste layer 12 was formed. In this manner, capacitor element 2 was obtained.

(8) Assembling of Electrolytic Capacitor

Capacitor element 2 on which anode terminal 4, cathode terminal 5, and adhesive layer 14 are disposed were sealed with resin sealing material 3 to produce an electrolytic capacitor.

### Comparative Example 1

Polyanilinesulfonic acid was used in place of poly(3,4-ethylenedioxythiophene) having a sulfonate group. Except for this change, the first liquid composition was prepared similarly to Example 1, and an electrolytic capacitor was produced.

### Comparative Example 2

Polyisothianaphthene having a sulfonate group was used in place of poly(3,4-ethylenedioxythiophene) having a sulfonate group. Except for this change, the first liquid composition was prepared similarly to Example 1, and an electrolytic capacitor was produced.

[Evaluation]

The electrolytic capacitors of the example and the comparative examples were evaluated as follows.

(a) Measurement of ESR

An ESR value (mo) at a frequency of 100 kHz of the electrolytic capacitor was measured as an initial ESR value, in an environment of 20° C. using an LCR meter for 4-terminal measurement. Further, in order to evaluate stability of ESR in high-temperature environments, after a rated voltage had been applied to the electrolytic capacitor at a temperature of 145° C. for 125 hours, an ESR value (mo) was measured by the same method as described above and defined as heat-resistance ESR.

The ESR values in each of the example and the comparative examples were evaluated by relative values with respect to the initial ESR and the heat-resistance ESR in Comparative Example 1 that were respectively defined as 100.

(b) Measurement of Heat-Resistance Low-Frequency Tan δ

After a rated voltage had been applied to the electrolytic capacitor at a temperature of 145° C. for 125 hours, tan δ (%) at a frequency of 120 Hz of the electrolytic capacitor was measured in an environment of 20° C., using an LCR meter for 4-terminal measurement.

The heat-resistance low-frequency tan δ in each of the example and the comparative examples was evaluated by relative values with respect to a value of the heat-resistance low-frequency tan δ in Comparative Example 1 that was defined as 100.

Table 1 shows evaluation results. A1 denotes Example 1, and B1 and B2 denote Comparative Examples 1 and 2, respectively.

TABLE 1

| | Initial | Heat-resistance | Heat-resistance |
|---|---|---|---|
| | ESR | low-frequency tanδ | ESR |
| A1 | 99 | 58.5 | 79.8 |
| B1 | 100 | 100 | 100 |
| B2 | 108 | 76.9 | 88.6 |

As Table 1 shows, A1 of the example exhibits a lower initial ESR and a lower heat-resistance ESR that is a value after exposed to the high-temperature environment than those in B1 and B2. A1 also exhibited a lower heat-resistance low-frequency tan δ than those in B1 and B2.

An electrolytic capacitor according to the present disclosure is usable for various applications in which a low ESR in high-temperature environments is required to be maintained.

What is claimed is:

1. An electrolytic capacitor comprising:
an anode body;
a dielectric layer disposed on the anode body; and
a solid electrolyte layer disposed on the dielectric layer, wherein:
the solid electrolyte layer includes a conductive polymer, and
the conductive polymer contains a self-doped poly(3,4-ethylene dioxythiophene)-based polymer.

2. The electrolytic capacitor according to claim 1, wherein the self-doped poly(3,4-ethylenedioxythiophene)-based polymer has a sulfonate group or a salt of the sulfonate group.

3. The electrolytic capacitor according to claim 1, wherein:
the solid electrolyte layer includes a first conductive polymer layer and a second conductive polymer layer, the first conductive polymer layer being disposed on the dielectric layer and containing a first conductive polymer, the second conductive polymer layer being disposed on the first conductive polymer layer and containing a second conductive polymer, and
the first conductive polymer is the self-doped poly(3,4-ethylene dioxythiophene)-based polymer.

4. The electrolytic capacitor according to claim 3, wherein the second conductive polymer is a non-self-doped polymer.

5. The electrolytic capacitor according to claim 3, wherein the second conductive polymer is polypyrrole.

6. The electrolytic capacitor according to claim 3, wherein the first conductive polymer layer has a smaller thickness than a thickness of the second conductive polymer layer.

7. A method for manufacturing an electrolytic capacitor, the method comprising steps of;
preparing an anode body on which a dielectric layer is disposed; and
forming a solid electrolyte layer on the dielectric layer, the solid electrolyte layer including a self-doped poly(3,4-ethylenedioxythiophene)-based polymer,
wherein the step of forming the solid electrolyte layer includes a step of forming a first conductive polymer layer that contains the self-doped poly(3,4-ethylenedioxythiophene)-based polymer as a first conductive polymer, by attaching a first liquid composition that contains the self-doped poly(3,4-ethylenedioxythiophene)-based polymer onto the dielectric layer.

8. The method for manufacturing an electrolytic capacitor according to claim 7, wherein the step of forming the solid electrolyte layer further includes a step of forming a second conductive polymer layer that contains a second conductive polymer, by attaching a second liquid composition that contains the second conductive polymer or a precursor of the second conductive polymer onto the first conductive polymer layer.
